(19) United States
(12) Patent Application Publication
(10) Pub. No.: US 2026/0185604 A1
(43) Pub. Date: Jul. 2, 2026

(54) GEAR COMPONENT HAVING AN EMERGENCY LUBRICATING DEVICE

(71) Applicants: ZF FRIEDRICHSHAFEN AG, Friedrichshafen (DE); ZF Wind Power Antwerpen N.V., Lommel (BE)

(72) Inventors: Wim De Laet, Antwerpen (BE); Rob Lambrechts, Lommel (BE); Maarten Ooms, Geel (BE)

(21) Appl. No.: 19/129,027

(22) PCT Filed: Oct. 23, 2023
(86) PCT No.: PCT/EP2023/079403

§ 371 Date: May 12, 2025

(30) Foreign Application Priority Data
Nov. 25, 2022 (DE) 10 2022 212 593.2

(51) Int. Cl. F16H 57/04; F16H 57/02; F16H 57/027; F16H 57/08

(52) U.S. Cl. CPC F16H 57/0442; F03D 80/70; F16H 57/027; F16H 57/0421; F16H 57/0424; F16H 57/0479; F16H 57/082; F16N 11/04; F16N 29/02; F16H 2057/02078; F16N 2260/20

(57) ABSTRACT

A gearbox component, including at least one bore configured to conduct oil between two openings, a plug which is arranged and fixed at least partially in the at least one bore, an axially displaceable piston arranged in the at least one bore, and a spring which is braced between the plug and the piston. The spring and the plug are located on a different side of the piston relative to the two openings.

### CROSS REFERENCE TO RELATED APPLICATIONS

This application is a U.S. National Phase application under 35 U.S.C. § 371 of International Application No. PCT/EP2023/079403, filed on Oct. 23, 2023, and claims benefit to German Patent Application No. DE 10 2022 212 593.2, filed on Nov. 25, 2022. The International Application was published in German on May 30, 2024 as WO 2024/110133 A1 under PCT Article 21(2).

### FIELD

The invention relates to a gearbox component.

### BACKGROUND

Wind turbines in operation must occasionally be taken out of service, for example in the event of a fault or during strong winds. When operation stops, the lubricant pressure generated by a lubricant pump mechanically integrated into the drivetrain drops, while the gearbox is fully loaded by the wind still acting on the rotor. This can result in damage to the bearings and gears due to insufficient lubrication.

Electric lubricant pumps are comparatively susceptible to defects and are further dependent on the presence of an electrical power supply. In the case of a defect of the pump or a failure of the electrical power supply, lubrication will also be insufficient, with the consequences described above.

A system for emergency lubrication is known from EP 3074689 A1. The lubricant is pressurized by means of a spring-loaded piston. This pressure is sufficient to bring the gearbox to a safe standstill in the event of an imminent insufficiency of lubrication. The piston is housed in a separate container. On the one hand, this increases the installation space required and, on the other hand, it prevents the piston from being positioned in the immediate vicinity of the lubrication points.

### SUMMARY

In an embodiment, the present disclosure provides a gearbox component, comprising at least one bore configured to conduct oil between two openings, a plug which is arranged and fixed at least partially in the at least one bore, an axially displaceable piston arranged in the at least one bore, and a spring which is braced between the plug and the piston. The spring and the plug are located on a different side of the piston relative to the two openings.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a planet pin;

FIG. 2 illustrates an emergency lubrication device in a relaxed state; and

FIG. 3 illustrates the emergency lubrication device in a braced state.

### DETAILED DESCRIPTION

In an embodiment, the present disclosure provides an improved emergency lubrication.

The gearbox component according to the present disclosure has at least one bore for conducting oil. The bore is thus configured as part of an oil line of the gearbox. This means that the bore has an inlet opening and an outlet opening for the oil. Oil that enters the bore via the inlet opening is directed from the bore to the outlet opening and exits the bore there. The openings can each be arranged coaxially to a center axis of the bore or in a lateral surface of the bore. In particular, one opening can be arranged coaxially to the center axis of the bore, while the other opening is arranged in the lateral surface. An opening arranged coaxially to the center axis of a bore is identical to an opening through which a drill bit passes when completing the bore.

The gearbox component also has a means that is arranged at least partially in the bore. At least part of the means, preferably the entire means, is hence located in the bore. Furthermore, the means is fixed in the bore. Preferably, the means is rigidly fixed in the bore, i.e. in such a way that no relative movements between the means and the bore are possible.

According to the present disclosure, the gearbox component has a piston that is arranged in the bore and can be displaced relative to the bore in the axial direction, i.e. along the center axis of the bore. Preferably, the piston is sealed in a fluid-tight manner relative to a lateral surface of the bore. For this purpose, the piston has, for example, one or more sealing rings which are arranged coaxially to the center axis of the bore and extend between the piston and the lateral surface.

Furthermore, the gearbox component has a spring. This generally refers to a means for applying a spring force. For example, it can be a coil spring. The spring is braced between the means and the piston. This means that the spring exerts oppositely directed spring forces of equal magnitude on the means and the piston. The spring forces act outwards starting from the spring. This causes the means and the piston to be pushed apart.

The spring with the means and the two openings mentioned above are located on different sides of the piston. Thus, the spring with the means is therefore located on one side of the piston, while the openings are located on the other side of the piston. The piston divides the bore into a first hollow space and a second hollow space. The first hollow space and the second hollow space are located on different sides of the piston. The spring and the means are arranged in the first hollow space. The second hollow space defines the openings. It serves to guide oil from the inlet opening to the outlet opening.

Oil that is located in the second hollow space is pressurized via the spring and the piston. This allows the oil pressure to be maintained for a short time in the event of a primary lubricant supply failure and the gearbox to be brought to a safe standstill.

The configuration in a gearbox component according to the present disclosure is particularly advantageous, as no additional installation space is required. This allows an arrangement in the immediate vicinity of a lubrication point.

In an embodiment, the means is screwed into the bore. This simplifies the mounting of the means. The bore is preferably provided with an internal thread and the means with an external thread, which is screwed into the internal thread.

Preferably, the gearbox component is further configured with a sleeve that is at least partially, preferably completely, arranged and fixed in the bore. Preferably, the sleeve is rigidly fixed in the bore, i.e. in such a way that no relative movements between the sleeve and the bore are possible. In particular, it can be an at least partially hollow cylindrical sleeve.

The means in turn is at least partially, preferably completely, arranged and fixed in the sleeve. Preferably, the means is rigidly fixed in the sleeve, i.e. in such a way that no relative movements between the means and the sleeve are possible.

According to an embodiment, the piston is also arranged in the sleeve. In particular, the piston can be sealed in a fluid-tight manner relative to a lateral surface of the sleeve. For this purpose, the piston has one or more sealing rings, for example, which are arranged coaxially to the center axis of the bore and extend between the piston and the lateral surface.

As the piston is displaceable within the bore and the sleeve is fixed in the bore, the piston is also displaceable within the sleeve. As a result, the piston performs the function described above in conjunction with the sleeve. The spring is also arranged in the sleeve according to an embodiment.

The use of a sleeve according to an embodiment is advantageous, as the piston, the means and the spring can be pre-assembled in the sleeve. Subsequently the arrangement consisting of sleeve, means, spring and piston is inserted into the bore and fixed there. This simplifies the assembly. In addition, there is no need for elaborate reworking to smooth the lateral surface of the bore, as the piston is guided by a lateral surface of the sleeve.

Preferably, the sleeve has an internal and an external thread. Via the external thread it is screwed into a corresponding internal thread of the bore. The means in turn preferably has an external thread corresponding to the internal thread of the sleeve, with which it is screwed into the internal thread of the sleeve.

In an embodiment, the means has an air intake and exhaust ventilation opening. This connects the first hollow space to the environment in a gas-conducting manner. Thereby it is prevented that the air in the first hollow space is compressed and thus works against the spring force.

In an embodiment, the gearbox component is configured as a gearbox housing, planet carrier or planet pin. The gearbox housing, the planet carrier or the planet pin therefore has the bore described above, the means, the piston and the spring.

Preferably, the gearbox component is configured as part of a wind power gearbox. This has at least one oil line, which is configured to supply at least one lubrication point with oil. Lubrication point refers to a component of the wind turbine gearbox that must be supplied with oil during operation to protect it from wear. This can be a gearwheel or a bearing, for example a planetary gear bearing.

According to an embodiment, the bore forms a first part of the oil line. A second part of the oil line is then connected to the inlet or outlet opening of the bore in an oil-conducting manner. In particular, the second part can be connected to the inlet opening in an oil-conducting manner, while a third part of the oil line is connected to the outlet opening in an oil-conducting manner.

In an embodiment, a lubricant pressure, which is generated by an oil pump, acts on the piston. This causes the piston to move in the direction of the means, so that the spring is braced between the means and the piston. As a result, a force applied to the piston by the spring counteracts the lubricant pressure. If the pressure applied by the oil pump drops, the lubricant pressure in the oil line is maintained for a while by the braced spring. This allows the wind turbine gearbox to be brought to a standstill without the risk of insufficient lubrication.

Embodiments of the present disclosure are shown in the figures. Corresponding reference numerals indicate identical or functionally identical features.

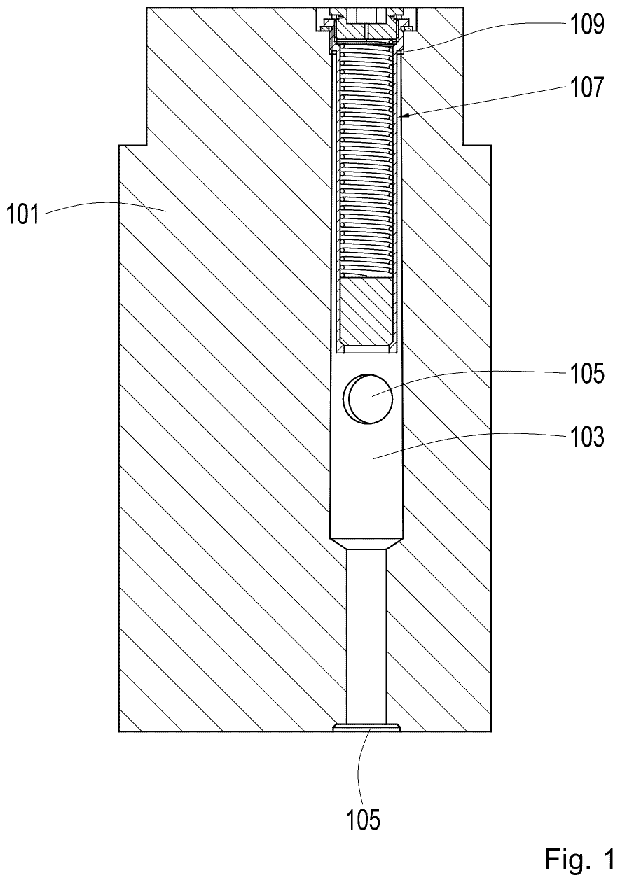

The planet pin 101 shown in FIG. 1 has a bore 103. This is used to supply a planetary gear bearing with oil. For this purpose, the bore 103 has two openings 105 through which the oil enters and/or exits the bore 103. Depending on the direction of flow of the oil, the openings 105 can optionally serve as inlet or outlet openings.

In order to supply the planetary gear bearing with sufficient oil in the event of a failure of a regular lubricant supply or in the event of a gearbox stop, an emergency lubrication device 107 is recessed into the bore 103. The bore 103 has an internal thread 109.

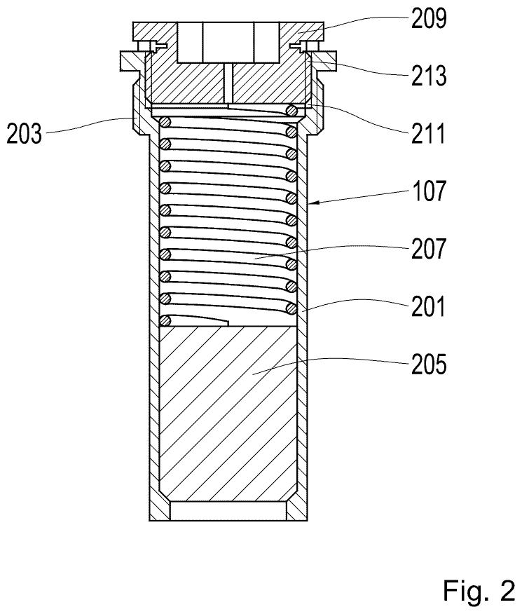

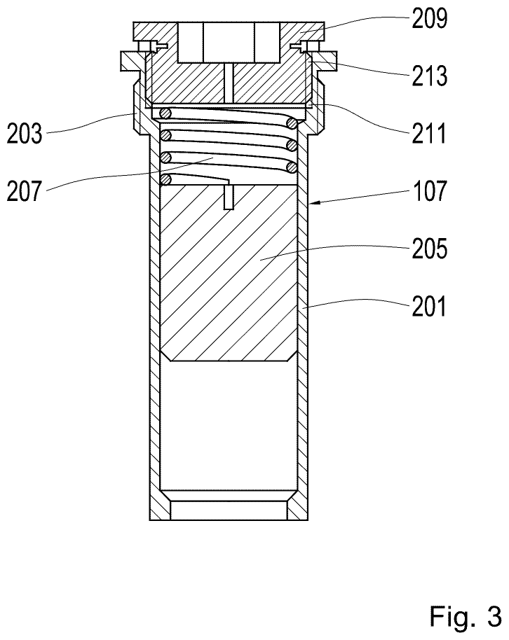

FIGS. 2 and 3 show the emergency lubrication device 107 in detail. In accordance with this, the emergency lubrication device 107 is housed in a sleeve 201. This has an external thread 203, which is screwed to the internal thread 109 of the bore 103.

A piston 205, a spring 207 and a plug 209 are located inside the sleeve 201. The plug 209 forms an external thread 211, which is screwed to a corresponding internal thread 213 of the sleeve 201.

The spring 207 is braced between the piston 205 and the plug 209. It exerts opposing, outwardly acting spring forces on the piston 205 and the plug 209.

FIG. 2 shows the emergency lubrication device 107 in a relaxed state. The emergency lubrication device 107 assumes this state when there is no oil pressure.

If oil pressure is built up by the primary oil pump during regular operation, this acts on the piston 205 and moves it in the direction of the plug 209. A corresponding position of the piston 205 is shown in FIG. 3.

The spring 207 is compressed by the movement of the piston 205. When the oil pressure drops, the piston 205 moves in the opposite direction. Due to the spring force acting on the piston 205 the drop in oil pressure can be compensated for until the piston has reached its original position, as shown in FIG. 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

101 planet pin
103 bore
105 opening
107 emergency lubrication device
109 internal thread
109 internal thread
201 sleeve
203 external thread
205 piston
207 spring
209 plug
211 external thread
213 internal thread

1. A gearbox component comprising:
at least one bore configured to conduct oil between two openings;
a plug means which is arranged and fixed at least partially in the at least one bore;
an axially displaceable piston arranged in the at least one bore; and
a spring which is braced between the plug and the piston,
wherein the spring and the plug are located on a different side of the piston relative to the two openings.

2. The gearbox component according to claim 1, wherein the plug is screwed into the at least one bore.

3. The gearbox component according to claim 1, further comprising a sleeve arranged and fixed at least partially in the at least one bore,
wherein the plug is arranged and fixed at least partially in the sleeve, and
wherein the piston is arranged in the sleeve.

4. The gearbox component according to claim 1, wherein one the plug has an air intake and exhaust ventilation opening.

5. The gearbox component according to claim 1, wherein the gearbox component is configured as a gearbox housing, a planet carrier, or a planet pin.

6. A wind power gearbox, comprising:
at least one oil line configured to supply at least one lubrication point with oil; and
the gearbox component according to claim 1,
wherein the at least one bore forms a part of the at least one oil line.
